(19) United States
(12) Patent Application Publication
(10) Pub. No.: US 2015/0121757 A1
(43) Pub. Date: May 7, 2015

(54) WATERING DEVICE

(71) Applicant: PROVIDE COMMERCE, INC., San Diego, CA (US)

(72) Inventor: Hani Yassin, San Diego, CA (US)

(73) Assignee: PROVIDE COMMERCE, INC., San Diego, CA (US)

(21) Appl. No.: 14/527,169

(22) Filed: Oct. 29, 2014

Related U.S. Application Data
(60) Provisional application No. 61/898,981, filed on Nov. 1, 2013.

(51) Int. Cl. A01G 31/02

(52) U.S. Cl. CPC A01G 31/02
USPC 47/62 R

(57) ABSTRACT

An example arrangement includes a vessel, a foam block positioned within the vessel, and a watering device positioned at least partially within the foam block. The watering device may include a reservoir portion positioned outside the foam block and a stem portion in fluid communication with the reservoir portion, the stem portion having one or more holes positioned within the foam block.

### RELATED APPLICATIONS

The present application claims priority under 35 U.S.C. §119(e) from U.S. Provisional Patent Application Ser. No. 61/898,981, filed Nov. 1, 2013, and titled “WATERING DEVICE”, which is hereby incorporated by reference in its entirety and for all purposes.

### BACKGROUND

Watering of plants and flowers is a necessity, but one that can be tedious and difficult to accomplish with accuracy. Most plants that are potted in soil may allow more flexibility since the soil can hold some water but may nevertheless require watering regularly (e.g., daily). Cut flowers that may be place in a vase may require the water to be replenished more often.

### BRIEF DESCRIPTION OF THE DRAWINGS

For a more complete understanding of various examples, reference is now made to the following descriptions taken in connection with the accompanying drawings in which:

FIG. 1 illustrates a watering device in accordance with an example;

FIG. 2 illustrates an example floral arrangement in accordance with an example of the present disclosure;

FIG. 3 illustrates the example arrangement of FIG. 2 with the flowers removed for ease of understanding; and

FIG. 4 is a cross-sectional view of the arrangement of FIG. 3 taken along IV-IV.

### DETAILED DESCRIPTION

In order to maintain a healthy state, flowers and plants must be supplied with water regularly and, in some cases, substantially continuously. In particular, cut flowers which are often sold or delivered as floral arrangements are generally placed in a vase filled with water. Water in a vase can be problematic, particularly if the floral arrangement is being delivered, for example, through a courier service to a resident or a business.

Various examples described herein provide a system and arrangement for secure transportation of plants and flowers. The plants or flowers may be provided with a sufficient supply of water and may also be provided with a mechanism for maintaining a sufficient water level once delivery is complete.

In one example, flowers are placed in a vase that contains a block of water-absorbing foam. The block of foam can act as a sponge that holds water therein. The flowers can access the water from the foam, while spillage of the water is avoided. The stems of the flowers may be embedded within the foam. Thus, prior to delivery, the foam may be saturated with water. The flowers may then be cut and placed in the vase, with the stems of the flowers embedded in the water-saturated foam. The flowers may then be delivered by, for example, a regular delivery service without the special care normally required for flower delivery. In this regard, the flowers may be placed in a box for delivery. A normal delivery service for delivery of boxes, rather than a specialized flower delivery, may thus be used to deliver the flowers.

Once the flowers are received by the intended recipient, the flowers may be displayed. In accordance with the various examples described herein, the flowers may be kept in the vase with the block of foam. The recipient may simply add water to the foam, and the foam may store the water and supply the water to the flowers through the stems embedded in the foam. Supplying water to the foam may be facilitated through the use of a watering device, examples of which are described herein.

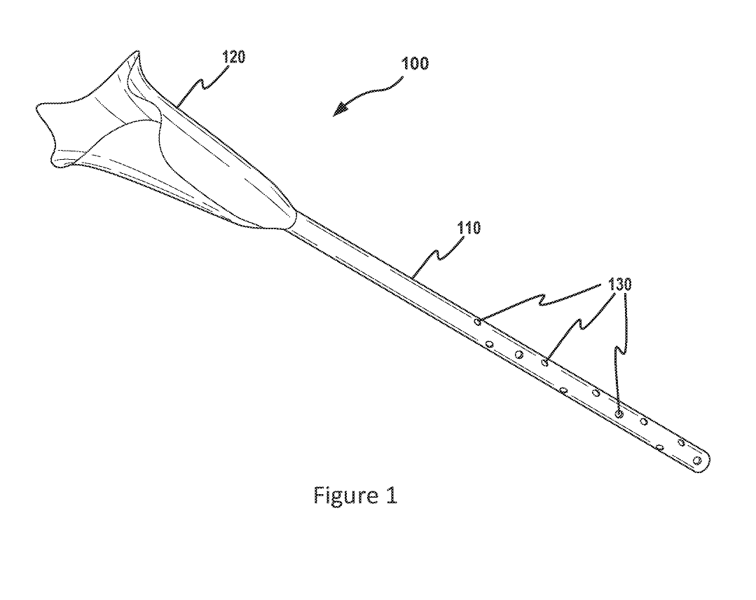

Referring now to FIG. 1, an example of a watering device 100 is illustrated. The example watering device 100 includes a stem 110 formed as a hollow shaft and a water reservoir 120. The stem 110 may be formed of a variety of materials. In one example, the stem 110 is formed of a hard plastic or a light metal. As described below, the length of the stem 110 may be determined based upon the size of the vase or bouquet. As illustrated in the example of FIG. 1, the stem 110 has a generally cylindrical body with a hollow interior. The thickness of the cylindrical body may be selected based on several design factors, such as a desired rigidity to ensure penetration into a block of foam, for example. Further, the diameter of the hollow interior may be selected to provide a desired amount of water to flow to the block of foam, for example.

The water reservoir 120 of the watering device 120 may be formed in the shape of a funnel to receive water. Of course, while water is often used for feeding flowers and plants, any other fluid may be placed in the water reservoir 120 of the example watering device 120. For example, a solution to facilitate growth or freshness of the flowers or plants may be placed in the water reservoir 120. The size of the water reservoir 120 may be selected based on a variety of factors. In one example, the water reservoir 120 is sized to hold an amount of water needed for a bouquet for a single day.

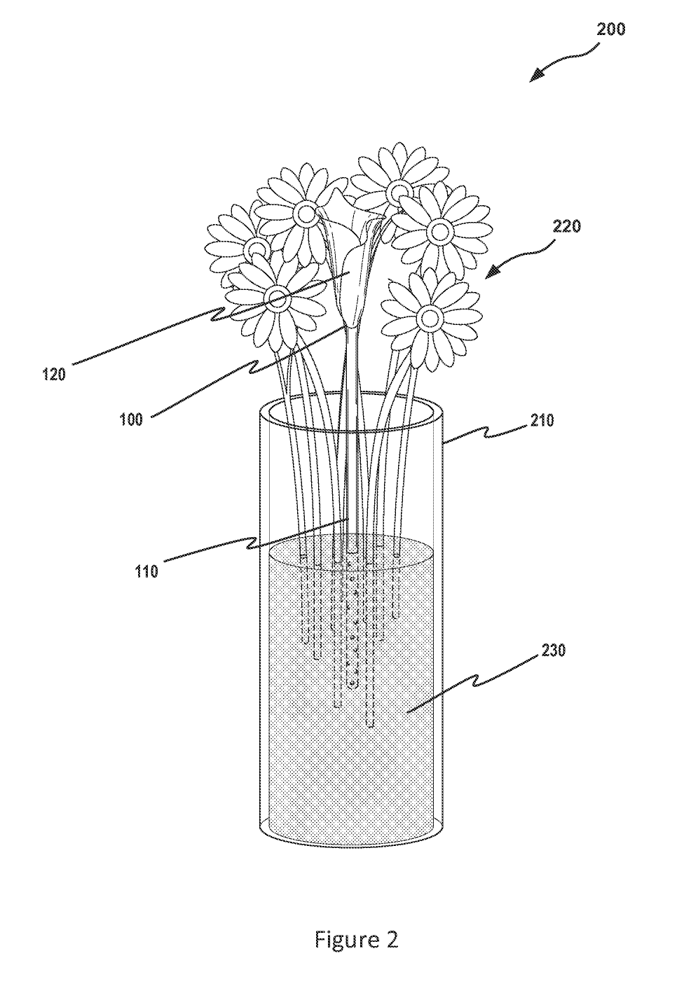

In the example illustrated in FIG. 1, the water reservoir 120 is shaped as a flower. As described below with reference to FIG. 2, shaping the water reservoir 120 as a flower may serve to camouflage the water reservoir 120, as well as the entire watering device 120, within the bouquet. In other examples, the water reservoir 120 may have other shapes, such as a simple cone or funnel shape.

The stem 110 of the example watering device 100 includes holes 130. The number and the size of the holes may be based on various factors. For example, the holes 130 may be sized based on the size and density of the foam in which a bouquet may be placed, as described below with reference to FIG. 2. In one example, the water is absorbed by the foam slowly over a lengthy time period to maintain a saturation level of the foam. In other examples, the water flows rapidly out of the stem and into the foam and may overflow the foam, rising above the top of the foam.

Referring now to FIG. 2, an example arrangement 200 is illustrated. The arrangement 200 is formed with a vase 210. In the example illustrated in FIG. 2, the vase is a circular cylindrical vessel. In other examples, the vase may take any of a variety of shapes. Those skilled in the art will appreciate that the present disclosure is not limited to any particular shape of the vase and other shapes are contemplated within the scope.

The vase 210 has a floral bouquet 220 provided therein. The floral bouquet may include any number or any type of flowers. The flowers of the floral bouquet 220 are positioned within a block of foam 230. In particular, the stems of the flowers are embedded within the block of foam 230. The foam 230 is capable of absorbing and retaining water therein and can be saturated with water. Such foams are well known to those skilled in the art and do not require further discussion here. The block of foam 230 is sized and shaped to fit substantially snugly within the vase 210.

In one example, the foam has a volume of between about 150 cubic inches and 200 cubic inches. In other examples, the foam 230 is sized such that, when saturated with water, the foam 230 can hold sufficient water to allow the floral bouquet 220 to be supplied with water during a delivery period, for example. In this regard, the example arrangement 200 may be shipped to the recipient with a saturated block of foam 230.

In addition to the flowers of the floral bouquet 220, the foam 230 also supports a watering device 100. As noted above, in the illustrated example, the water reservoir 120 of the watering device 100 is shaped as a flower to blend into the floral bouquet. The stem 110 of the watering device 100 is implanted within the foam such that at least some of the holes 130 are within the foam 230.

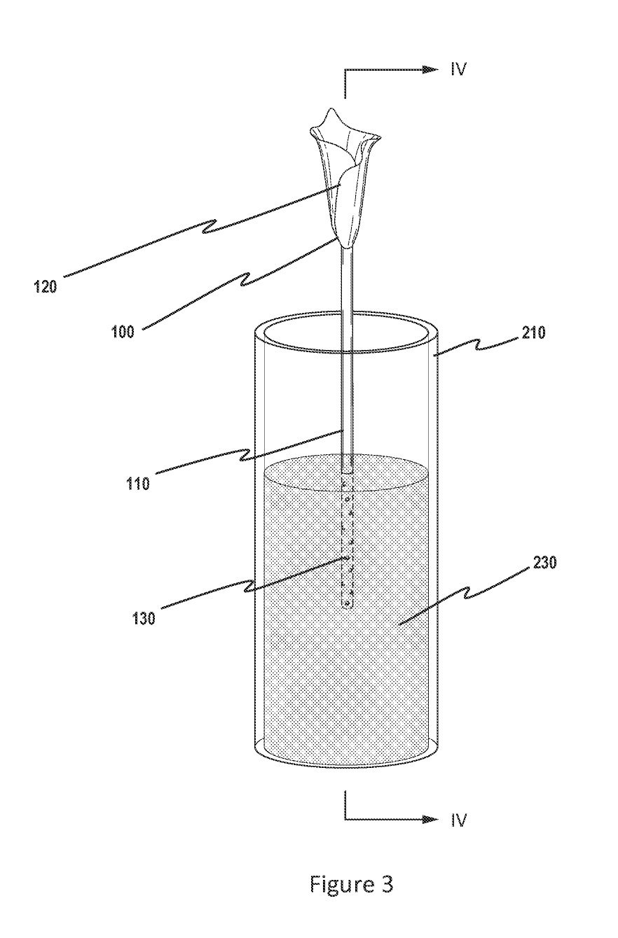

FIG. 3 more clearly illustrates the positioning of the watering device 100 within the block of foam 230. The floral bouquet 220 is removed in FIG. 3 to more clearly illustrate the watering device 100. As noted above, the stem 110 of the watering device 100 is implanted at least partially within the foam 230. At least some of the holes 130 in the stem 110 of the watering device 100 are positioned within the foam 230.

In one example, the stem is provided with between about 30 and about 50 holes that may be positioned either randomly or in any desired pattern. In one example, each hole has a diameter of approximately ⅛ inch.

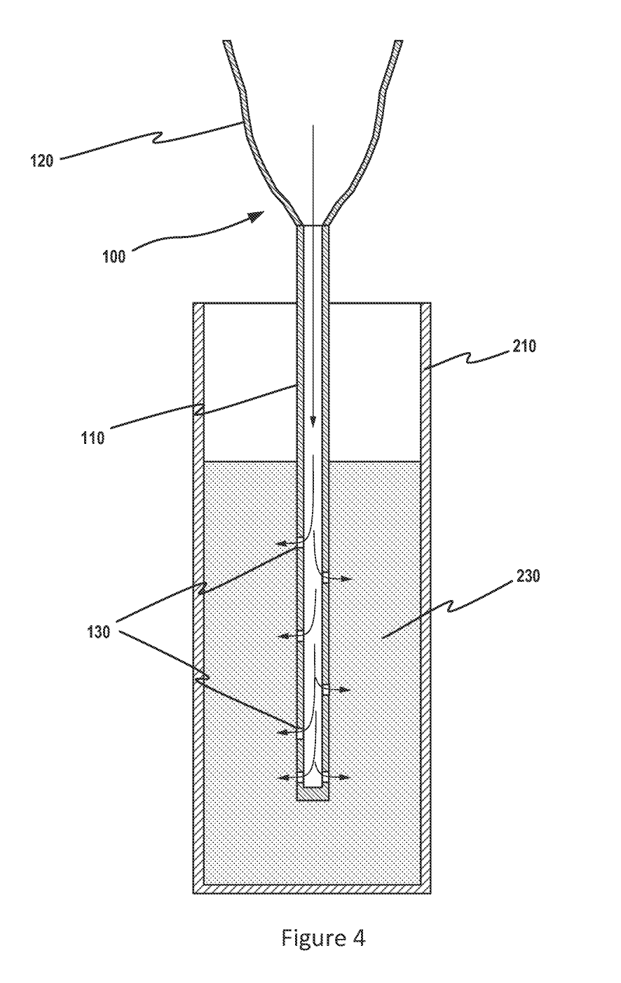

Referring now to FIG. 4, a cross-sectional view of the arrangement of FIG. 3 is provided. As noted above, the watering device 100 is implanted at least partially within the foam 230 in the vase 210. At least some of the holes 130 are positioned within the foam 230.

Thus, water may be poured into the water reservoir 120 of the watering device 100. Water may flow downward through the stem 110 of the watering device 100. The foam may absorb the water through the holes 130, as indicated by the arrows in FIG. 4.

Thus, once the arrangement is received by the recipient, the floral arrangement may be kept within the foam without the necessity to re-place it in another vase with water. Instead, water may be added to the water reservoir 120 at regular intervals (e.g., daily). The water may maintain the foam in wet or saturated state, allowing the flowers to be continuously watered through the foam.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A device, comprising:
a reservoir portion;
a stem portion in fluid communication with the reservoir portion, the stem portion having one or more holes.

2. The device of claim 1, wherein the reservoir portion is formed in the shape of a flower.

3. The device of claim 1, wherein the reservoir portion is configured to hold a liquid therein.

4. The device of claim 1, wherein the stem has a cylindrical shape with a hollow interior.

5. An arrangement, comprising:
a vessel;
a foam block positioned within the vessel;
a watering device positioned at least partially within the foam block, the watering device having:
a reservoir portion positioned outside the foam block; and
a stem portion in fluid communication with the reservoir portion, the stem portion having one or more holes positioned within the foam block.

6. The arrangement of claim 5, further comprising:
one or more flowers positioned within the foam block, the flowers receiving water from the foam block.

7. The arrangement of claim 5, wherein the reservoir portion is formed in the shape of a flower.

8. The arrangement of claim 5, wherein the reservoir portion is configured to hold a liquid therein.

9. The arrangement of claim 5, wherein the stem has a cylindrical shape with a hollow interior.
